(19) United States
(12) Patent Application Publication
(10) Pub. No.: US 2008/0291016 A1
(43) Pub. Date: Nov. 27, 2008

(54) Anti-Tamper Devices

(76) Inventor: Tracy Sharp, Middlesex (GB)

Correspondence Address: STITES & HARBISON PLLC, 1199 NORTH FAIRFAX STREET, SUITE 900, ALEXANDRIA, VA, 22314, US

(21) Appl. No.: 11/817,751

(22) PCT Filed: Mar. 1, 2006
(86) PCT No.: PCT/GB2006/000726

§ 371 Date: Jul. 17, 2008

(30) Foreign Application Priority Data
Mar. 1, 2005 (GB) 0504176.9

(51) Int. Cl. G08B 21/00

(52) U.S. Cl. 340/540

(57) ABSTRACT

An anti-tamper device for detecting relative movement between a part (25) having a stud (12; 83) clamped to a mounting (24) by a nut (13; 55). The nut (13; 55) holds a sensor (7, 8, 9, 10; 41, 52, 54) in a conductive condition but, when the part (25) is removed from the mounting (24), the sensor (7, 8, 9, 10; 41, 52, 54) becomes non-conductive. A circuit is provided to provide and detect the change of state of the sensor to provide an alarm. The device may be used to detect the removal of a keypad from a mounting.

The invention relates to anti-tamper devices.

A part clamped to a mounting by a fixing means such as a stud and nut can be subjected to tampering and there can be a need to know whether tampering is taking place. For example, if the part is a keypad such as used in an automated cash dispenser, it is important that any attempt to remove the keypad from the associated mounting is detected.

According to the present invention, an anti-tamper device for detecting relative movement between a part and a mounting to which the part is clamped by fixing means from said clamped disposition comprising sensor having a first conductive condition and a second non-conductive condition, the fixing means, in when the part is clamped to the mounting maintaining the sensor in one said condition and, on a movement of the fixing means when the part is unclamped from said mounting allowing the sensor to adopt the other said condition, and a circuit for detecting the condition of the sensor, and for producing a signal on movement of the sensor from one condition to the other condition.

The following is a more detailed description of some embodiments of the invention, by way of example only, reference being made to the accompanying drawings in which:—

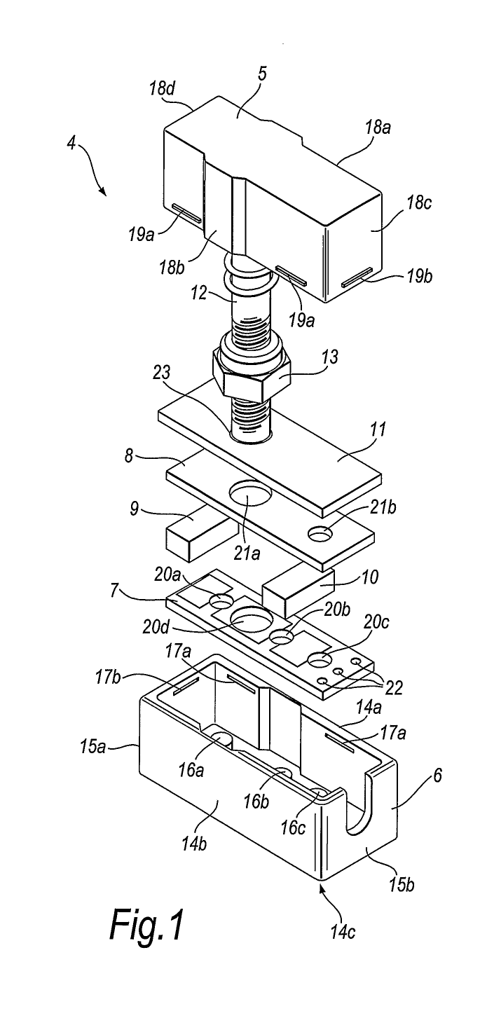

FIG. 1 is an exploded view of a first form of anti-tamper device,

FIG. 2 shows an underneath plan view of part of a keypad and a keypad mounting showing a bolt extending from the mounting through the keypad mounting,

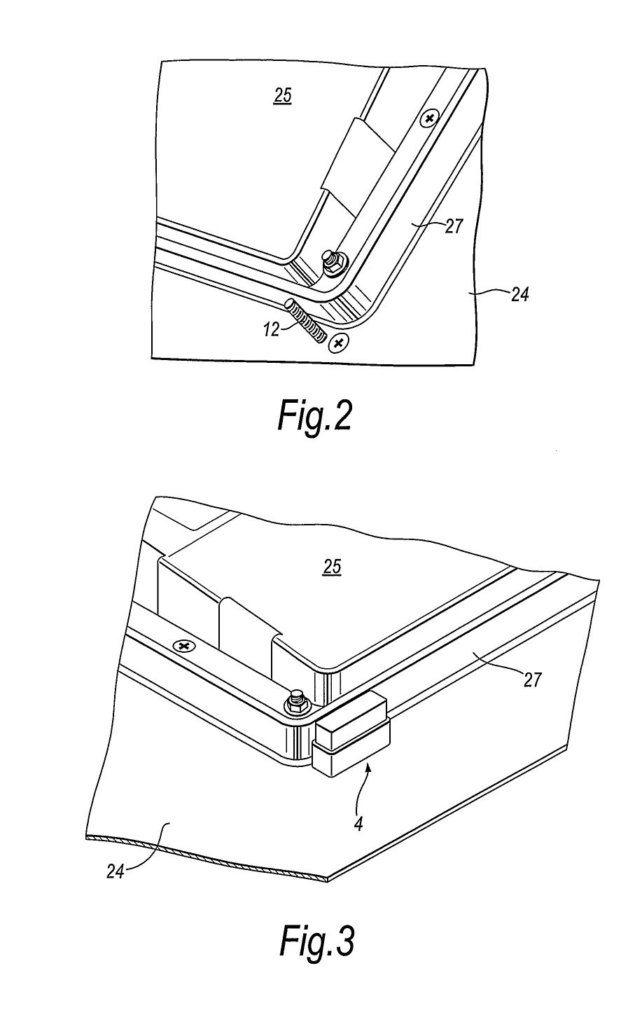

FIG. 3 is a similar view to FIG. 2 but including the anti-tamper device of FIG. 1; and

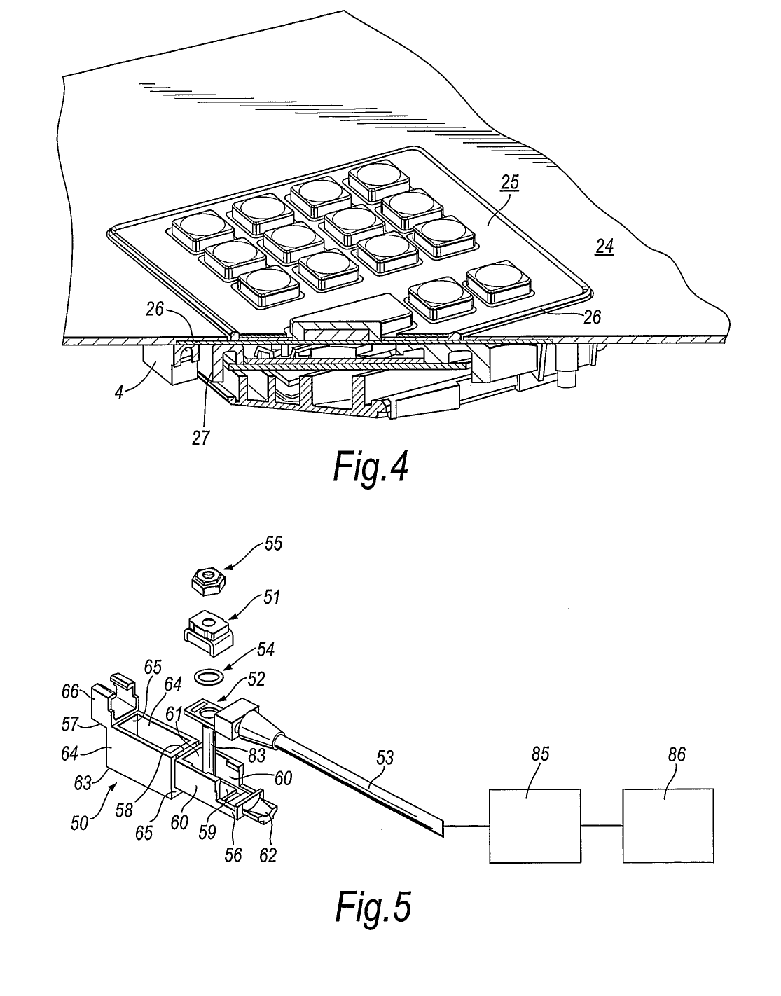

FIG. 4 is a perspective view, partially in cross-section, of the keypad and keypad housing of FIG. 3,

FIG. 5 is an exploded view of a second form of anti-tamper device including a printed circuit board and an over-moulding assembly,

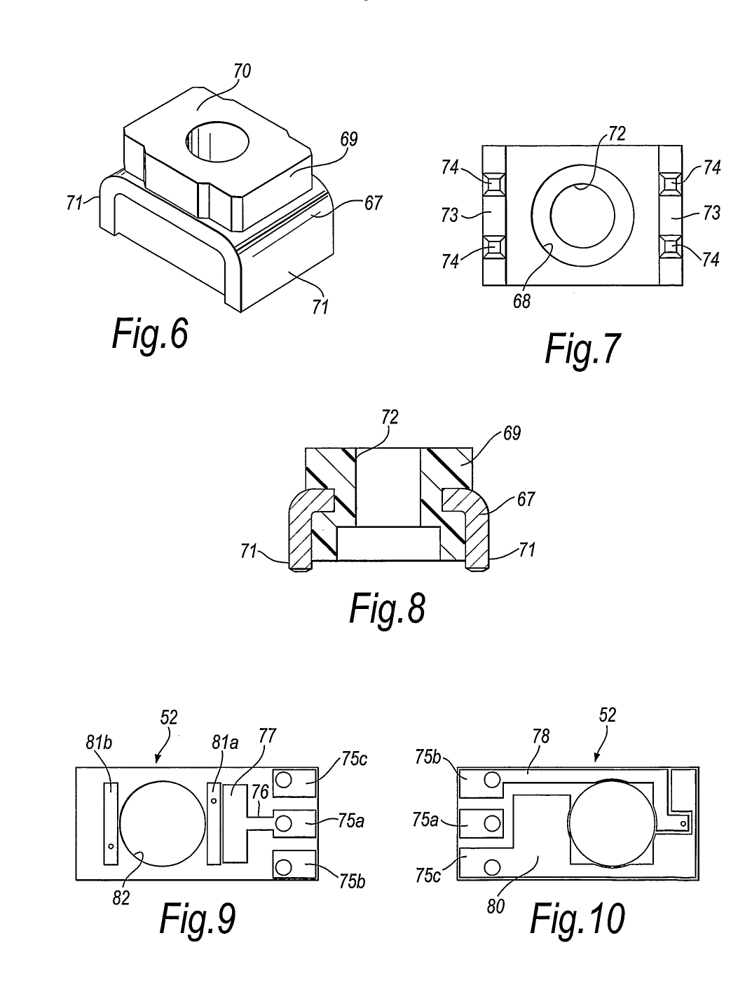

FIG. 6 is a perspective view of the over-moulding assembly,

FIG. 7 is an underneath plan view of the over-moulding assembly,

FIG. 8 is a cross-section through the over-moulding assembly,

FIG. 9 is a plan view from beneath of the printed circuit board and;

FIG. 10 is a plan view from above of the printed circuit board.

Referring to FIG. 1 the first form of anti-tamper device 4 includes a housing comprising a cover 5 and a base 6. The housing contains a sensor formed by first and second printed circuit boards 7, 8, a pair of Zebra™ elastomeric connectors 9, 10, a plate 11, a stud 12 and nut 13.

The base 6 is of generally open-box shape having a base wall 14c surrounded by two opposed longer sides 14a, 14b and two opposed shorter sides 15a, 15b. Three projections 16a, 16b, project inwardly from the base 14c and an aperture (not shown) extends through the base wall 14c. Each longer side 14a, 14b has two recesses 17a adjacent the free end of the side, 14a, 14b. One shorter side 15a has one recess 17b adjacent the free end of the side 15a. The other shorter side 15b has a U-shaped cut-out extending from its open edge.

The cover 5 is of similar general shape to the base 6 but inverted with respect to the base 6 with longer sides 18a, 18b, shorter sides 18c, 18d and a top wall 18c. Each longer side 18a, 18b has two projections 19a adjacent the free end of the side 18a, 18b, to snap-fit with the associated recesses 17a on the longer sides 14a, 14b of the base 6. Each shorter side 18c, 18d has a single projection 19b adjacent the free end of the side 18c, 18d and one of these projections 19b is a snap-fit with the recess 17b on a the shorter side 15a of the base 6.

The first printed circuit board 7 is formed with three smaller holes 20a, 20b, 20c and one larger hole 20d. The first printed circuit board 7 has a side opposing and spaced from a side of the second printed circuit board 8, which has a larger hole 21a therethrough in register with the larger hole 20d of the first printed circuit board 7 and a smaller hole 21b in register with hole 20c. The printed circuit boards 7, 8 have wires (not shown) attached thereto at connectors 22. The wires extend out of the device 4 through the cut-out in the base 6 to connect to a circuit (not shown). The circuit includes means (not shown) for inputting and for receiving a signal. The circuit further includes means for detecting whether a signal has been received and for producing an alarm signal on receipt of a signal.

The elastomeric connectors 9, 10 are Zebra™ elastomeric connectors in the form of rectangular cross-section blocks. These connectors 9, 10 have a compressed state in which the connectors 9, 10 are conductive and an uncompressed state in which the connectors 9, 10 are non-conductive.

Referring next to FIGS. 2, 3 and 4, the anti-tamper device is designed to be used with a keypad assembly of the kind shown in these Figures. The keypad assembly comprises a generally rectangular keypad 25 having a peripheral flange 26 carried in a rectangular aperture 27 in a mounting plate 24. The general form of the keypad 25 is well known and will not be described in detail.

The keypad 25 is mounted on to the keypad housing 24 by the stud 12 which extends through the keypad housing 24 and through the flange 26 adjacent a depending peripheral wall 27 of the keypad 25. The position of the stud 12 is shown in FIG. 2.

The anti-tamper device 4 as described above with reference to FIG. 1 is mounted on the stud 12 in the following way. First, the aperture in the base 6 is located on the free end of the bolt 12 beneath the keypad housing 24. The first printed circuit board 7 is next located on the base with the three holes 20a, 20b, 20c engaging respectively on the three projections 16a, 16b, 16c on the base. The two elastomeric connectors 9, 10 are then located between the first printed circuit board 9, at spaced locations, with the connectors 9,10 extending transversely to the length of the printed circuit board.

The second printed circuit board 10 is then placed on the connectors 9, 10 with the hole 21b locating on one of the projections on the base wall 14c.

The plate 11 is of similar shape to the printed circuit boards 9, 10 and has a hole 23 therethrough. The plate 11 is placed over the second printed circuit board 9 with the hole 23 in register with the holes 20b, 21b in the first and second printed circuit boards 7, 8.

The nut 13, which is an M3 lock nut, is then screwed onto the free end of the stud 12 until it engages the plate 11. The nut 13 is then tightened to force the plate 11 and the second printed circuit board 8 towards the first printed circuit board 7 and the base wall 14c of the housing. Finally, the cover 5 is snap-fitted onto the base 6.

The elastomeric connectors 9, 10 are thereby compressed and are conductive. The circuit passes an electrical signal through the wires, through one of the printed circuit boards 7, through one of the elastomeric connectors 9, 10, through the other printed circuit boards 8, through the other of the elastomeric connectors 9, 10 and the signal exits the device 4 through an other of the wires for detection.

When the keypad 23 and housing 24 are tampered with so that the keypad 23 and housing 24 are moved from their normal relative disposition, by, for example, tampering with the bolt 12 wholly the tension in the stud 12 is reduced wholly or partially. The elastomeric connectors 7, 8 are therefore allowed to uncompress, thereby becoming electrically non-conductive. The circuit cannot therefore pass an electrical signal through the elastomeric connectors 7, 8 and, accordingly, no such signal is received by the signal receiving means. The means for detecting whether a signal is received then causes an alarm signal to be produced indicating tampering with the keypad assembly.

It will be appreciated that there are a number of variations that can be made to the embodiment described above. One or more than two zebra elastomeric connectors 7, 8 can be used. The elastomeric connectors 7, 8 could be replaced by other types of connector whose resistance varies on compression. It should be noted that only one connector need be uncompressed for the passage of a signal through the device to be prevented.

The anti-tamper device described above could easily be adapted to prevent a signal passing through the elastomeric connectors when two members such as the keypad and keypad housing are in a normal relative disposition and to allow a signal to pass when the keypad or housing are moved their normal relative disposition.

The alarm signal could cause serve to sound a siren or to alert security personnel.

Referring next to FIG. 5, the second anti-tamper device comprises a housing 50, an over-moulding assembly 51, a printed circuit board 52, a connecting cable 53, a sealing ring 54 and a nut 55.

The housing 50 has a first housing part 56 a second housing part 57 connected by a hinge 58. The housing 50 is moulded in one piece from a plastics material.

The first housing part 56 has a rectangular base 59 with two side walls 60 and one end wall 61 extending between the side walls 60 at one end of the base 59. The side walls 60 extend only part way along the associated edges of the base 59 and the open end of the base has a catch part 62 projecting from the end. The base 59 has a central hole (not shown).

The second housing part 57 forms a lid for the first housing part 56 and comprises a rectangular base 63 surrounded by two side walls 64 and two end walls 65. The hinge 58 is provided between an end wall 65 of the second housing member 56 and the end wall 61 of the first housing part 56. The end wall 65 of the second housing part 57 remote from the hinge 58 carries a U-shaped catch member 66 for releasable latching engagement with the catch part 62 on the first housing part 56.

The over-moulding assembly 51 is shown in more detail in FIGS. 6, 7 and 8. The over-moulding assembly 51 comprises a generally U-shaped body 67 with a central aperture 68 formed of a conductive metal such as nickel, which may be gold plated for improved conductivity. A plastics moulding 69 of, for example, nylon, is moulded around the body 67 and extends through the central aperture 69 to form a generally rectangular stop surface 70 on the base of the U-shaped body 67 opposite the limbs 71. As seen in FIG. 6, the moulding has a central aperture 72. Each limb 71 has an end face 72 provided with two spaced frusto-pyramidal projections 74 for a purpose to be described below.

The printed circuit board 52 is best seen in FIGS. 9 and 10. The printed circuit board has three terminals 75a, 75b, 75c. The first terminal 75a is part of a first conductor 76 that extends over the outer surface of the printed circuit board 52 and terminates in a laterally extending first conductive strip 77. The second terminal 75b is part of a second conductor 78 that extends over the under surface of the printed circuit board 52 and connects with a second conductive strip 79 at an end of the printed circuit board 52 opposite the terminals 75a, 75b, 75c. The third terminal 75c is part of a third conductor 80 that extends beneath the printed circuit board 52 and connects to two thin conductive strips 81a, 81b extending laterally of the printed circuit board 52 on either side of a central aperture 82 and inwardly of the first and second conductive strips 77, 79.

The terminals 75a, 75b, 75c are connected to respective leads of the cable 53.

The sealing ring 54 is an O shaped compressive ring made of, for example, neoprene. The nut 55 is a conventional self-locking nut.

The second anti-tamper device described above with reference to FIGS. 5 and 10 is for use, for example, with a keyboard or keypad of the kind described above with reference to FIGS. 1 to 4. Any one of the bolts 83 (FIG. 5) mounting the keyboard is passed through the hole (not shown) in the base 59 of the first housing part 56. The printed circuit board 52, with the cable 53 attached, is then mounted on the bolt 83 with the stud 83 passing through the aperture 82 in the printed circuit board 52 and contacting with the strips 81a, 81b to provide an earth. The printed circuit board 52 and the base 59 are sized so that the printed circuit board fits closely between the side walls 60 and the end wall 61 of the first housing part 56. In addition, the cable 53 includes a mounting 84 that abuts the free ends of the side walls 60 of the first housing part 56. The sealing ring 84 is then passed over the stud 83 to rest on the upper face of the printed circuit board 52. The over-moulding assembly 51 is then also mounted on the stud 83 with the stud 83 passing through the aperture 73 in the moulding 69. The plastics moulding 69 prevents electrical connection between the bolt 83 and the body 67. In this position, the faces 73 of the U-shaped body 67 are in register respectively with the first and second strips 77, 79 but are held spaced from the first and second strips 77, 79 by the sealing ring 54.

The nut 55 is then threaded on to the stud 83 and bears against the stop surface 70 to compress the sealing ring 54 so that the projections 74 on the U-shaped body 67 engage respectively the first and second conductive strips 77 and 79. In this way, the electrical terminals 75a, 75b are electrically connected and an electric current can pass around the circuit.

If there is tampering with the keyboard by, for example, the stud 83 being drilled away or the unit being pierced by a drill or a sharp instrument or if the keypad is disturbed from its location, any loosening of the stud 83 will release the compression between the nut 55 and the printed circuit board 52 and the resilience of the sealing ring 54 will lift the over-moulding assembly 51 away from the printed circuited board 52. This will break the circuit and will be detected by the circuit 85 and this action can be used to operate an alarm 86 as described above with reference to FIGS. 1 to 4.

The application of the anti-tamper device is plainly not limited to detecting a relative movement of a keypad and a keypad housing—the device can be used in any article in which it is desired to detect the relative movement of two members from a normal disposition.

It will be appreciated that while the anti-tamper devices described above with reference to the drawings are clamped using a stud and a nut, this is not essential. The anti-tamper device could be used with any fixing means providing a clamping action such as post and washer or a nut and bolt or other fixing including an elongate member engaged by a fastening.

1. An anti-tamper device for detecting relative movement between a part and a mounting to which the part is clamped by fixing means from said clamped disposition comprising a sensor having a first conductive condition and a second non-conductive condition, the fixing means when the part is clamped to the mounting maintaining the sensor in one said condition and, on a movement of the fixing means when the part is unclamped from said mounting allowing the sensor to adopt the other said condition, and a circuit for detecting the condition of the sensor, and for producing a signal on movement of the sensor from one condition to the other condition.

2. An anti-tamper device according to claim 1 wherein the sensor comprises a first conductive member and a second conductive member held in electrical connection by the fixing means when the part is clamped to the mounting and, when the part is removed from the mounting, the electrical connection being broken, the circuit detecting said change to produce said signal.

3. An anti-tamper device according to claim 2 wherein the first conductive member and the second conductive member have a resilient member therebetween, the fixing means when the fixing means the part to the mounting, compressing the resilient member to hold the first and second conductive members in electrical connection, the release of said nut allowing the resilient member to move said first and second conductive members out of electrical connection.

4. An anti-tamper device according to claim 3 wherein the first conductive member and the second conductive member are mounted on an elongate member of the fixing means at axially spaced positions therealong, the resilient member comprising a resilient O-ring located on the elongate member between the first and second conductive members.

5. An anti-tamper device according to claim 1 wherein the first conductive member includes two spaced conductive zones and the second conductive member, when electrically connected to said first conductive member, electrically connecting said first and second zones to complete a circuit.

6. An anti-tamper device according to claim 5 wherein the first conductive member is a printed circuit board said zones being formed on said board, each zone leading to a respective terminal.

7. An anti-tamper device according to claim 6 wherein each terminal is connected to a respective electrical lead connected to said circuit.

8. An anti-tamper device according to claim 5 wherein said second conductive member is generally U-shaped with two limbs interconnected by a base, each limb contacting a respective conductive zone on the first conductive member when the part is fixed to the mounting.

9. An anti-tamper device according to claim 8 wherein the first conductive member and the second conductive member are mounted on an elongate-member of the fixing means at axially spaced positions therealong, the resilient member comprising a resilient O-ring located on the elongate member between the first and second conductive members and wherein the second conductive member includes a hole by which the second conductive member is mounted on the elongate member, the hole being surrounded by an insulating material to prevent electrical connection between the second conductive member and the elongate member.

10. An anti-tamper device according to claim 8 wherein the free end of each limb is provided with at least one projection for contacting the first conductive member.

11. An anti-tamper device according to claim 1 wherein the sensor comprises at least one device having a conductive compressed state and a non-conductive uncompressed state, said circuit including said at least one device, the nut compressing the at least one device when the part is clamped to the mounting and allowing the at least one device to be said in an uncompressed state when the part is removed from the mounting.

12. An anti-tamper device according to claim 11 wherein the or each device is a zebra elastomeric material.

13. An anti-tamper device according to claim 11 wherein the sensor includes first and second spaced circuit boards, said at least one device being is between said circuit boards and in electrical connection with a circuit of each of the circuit boards which is connected to said circuit for detecting the condition of the sensor.

14. A device according to claim 13 when the fixing means includes an elongate member that though the first and second circuit boards, and a fastening that bears against the second circuit board.

15. An anti-tamper device according to claim 1 and including a housing, said housing comprising a base, and a cover, the sensor being within said housing.

16. An anti-tamper device according to claim 1 wherein said cover and said base connect at a join.

17. An anti-tamper device according to claim 1 wherein the fixing means comprises a stud and a nut engaging the stud.

18. A system comprising a part and a mounting to which the part is clamped by fixing means and an anti-tamper device according to claim 1 acting between the part and the mounting.

19. A system according to claim 18 wherein said part is a keypad and the mounting is a keypad housing.
